(19) United States
(12) Patent Application Publication
(10) Pub. No.: US 2017/0150110 A1
(43) Pub. Date: May 25, 2017

(54) PROJECTING AN IMAGE ON AN IRREGULARLY SHAPED DISPLAY SURFACE

(71) Applicants: Ziv Nevo, Shoresh (IL); Oded Tweena, Jerusalem (IL); Aviad Sachs, Modi'in (IL)

(72) Inventors: Ziv Nevo, Shoresh (IL); Oded Tweena, Jerusalem (IL); Aviad Sachs, Modi'in (IL)

(21) Appl. No.: 14/951,571

(22) Filed: Nov. 25, 2015

(51) Int. Cl. H04N 9/31; G06T 7/00; G06T 7/60; G03B 21/606

(52) U.S. Cl. CPC H04N 9/3185; G03B 21/606; H04N 9/3194; G06T 7/0051; G06T 7/0085; G06T 7/60; G06T 2207/30242

(57) ABSTRACT

In accordance with some embodiments, the projector can adapt for virtually any surface of any shape and any complexity. A depth camera determines the configuration of the display surface. More particularly, the depth camera can produce an array of depth samples at a granularity determined to account for the complexity of the surface. A computer processor can take this array of samples and associated patches and adapt each patch to the local surface contour. Then all the patches can be combined and projected as a combined image that accounts for all the surface irregularities at the granularity at which the samples were taken. However, initially, the depth camera can be adapted to change the granularity or density of the sample points at which depths are calculated, based on an analysis of the complexity of the display surface.

### BACKGROUND

This relates generally to image projectors that display images produced by processor based systems.

Many projectors are available which can be coupled to a processor to display television, text, presentation slides or other content on a display surface.

In one situation, the display surface may be angled with respect to the projection beam. This causes an effect called keystoning which can be corrected using various algorithms.

### BRIEF DESCRIPTION OF THE DRAWINGS

Some embodiments are described with respect to the following figures:

FIG. 1 is a hardware depiction for one embodiment;

FIG. 2 is a depiction of a portion of a depth array according to one embodiment; and

FIG. 3 is a flow chart for one embodiment.

### DETAILED DESCRIPTION

In accordance with some embodiments, a projector may project a well-defined image on surfaces of any shape. For example, the projector can project an image onto a curve-shaped display surface so that the curvature of the display surface is accounted for. The image that is projected may be defined for planar projection but can be transformed so that it can be displayed clearly on a curved surface.

There are many applications for such a projector. In many situations, a user may project an image onto a wall surface which is not flat. It may be curved or it may have inside or outside corners in it. It may have a picture hanging on the surface which provides an irregular contour. A user may also wish to project an image onto another object, such as a statute, or any object so that it changes the appearance of that object.

In accordance with some embodiments, the projector can adapt for virtually any surface of any shape and any complexity. A depth camera determines the configuration of the display surface. More particularly, the depth camera can produce an array of depth samples at a granularity determined to account for the complexity of the surface. A computer processor can take this array of samples and associated patches and adapt each patch to the local surface contour. Then all the patches can be combined and projected as a combined image that accounts for all the surface irregularities at the granularity at which the samples were taken. However, initially, the depth camera can be adapted to change the granularity or density of the sample points at which depths are calculated, based on an analysis of the complexity of the display surface.

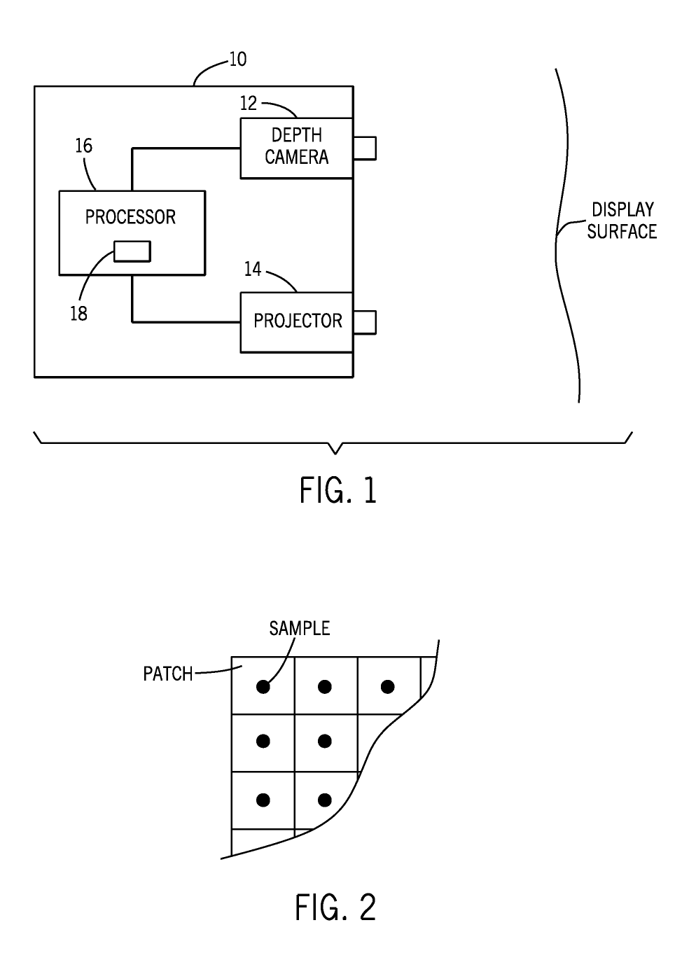

Referring to FIG. 1, in accordance with one embodiment, a unitary projector and depth camera may be used in one embodiment. Namely the depth camera may be integrated as part of a unitary package with a projector. In such case, the projector and the depth camera are pre-calibrated at the factory so that they can work together. In other embodiments, a separate depth camera and projector may be calibrated to work together.

Specifically as shown in FIG. 1, a unitary housing 10 may include a depth camera 12, projector 14 and processor 16 connected to both the depth camera 12 and projector 14. The processor 16 may include storage 18. The display surface may be any irregularly surface that the user wishes to project an image onto.

Initially, the depth camera images the display surface and creates a depth map that models the depth or distance from the projector to each of an array of sample points on the display surface. For more complex surfaces, more sample points are taken and the resulting array of depth values may be more detailed. For less complex surfaces, less detail may be needed and correspondingly less the lower number of samples may be taken.

Based on the depth array which is provided from the depth camera 12 to the processor 16, the processor can cause the planar image that is going to be displayed on the irregularly display surface to be modified to adapt to the irregularly shaped display surface. It does this by modifying each patch associated with each sample point. The patch is basically a grid of a region of predefined shape and size between adjacent sample points as shown in FIG. 2.

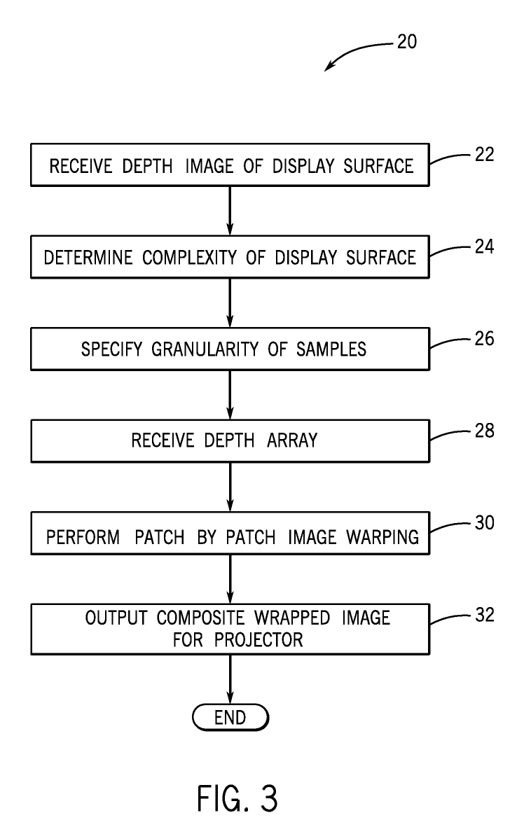

Referring to FIG. 3, in accordance with some embodiments, a sequence 20 may be implemented in software, firmware and/or hardware. In software and firmware embodiments it may be implemented by computer executed instructions stored in one or more non-transitory computer readable media. In accordance with some embodiments, it may be part of the storage 18 associated with the processor 16.

The sequence 20 begins by obtaining a depth image of a display surface from the depth camera 12 typically in response to user operation. Other ways of triggering the depth image may also be available including sensing various conditions such as a time, movement, identification of a particular object for tracking purposes for example.

Once the depth image is initially captured as indicated in block 22, it is analyzed to determine its complexity as indicated in block 24. In one embodiment, the number of edges identified within the display surface can be determined and compared to a table which determines complexity based on number of edges. Based on the complexity, a number of sample points for the ultimate depth image may be determined. Generally the more complex the display surface, the more samples that are taken and vice versa.

Then as indicated in block 26, the granularity of samples may be determined and specified to the depth camera 12 by the processor 16. As a result, the depth camera 12 captures a depth image of the display surface and transmits an array of depths whose numbers determined by the number of sample points identified by the processor based on complexity. Once the depth array has been received as indicated in block 28, each sample point is associated with an adjacent patch which surrounds the sample point. Typically the patch is centered on the sample point and the patches fill the entire depth image. In some cases, objects may have openings in them and these can be accounted for because there will simply be no samples provided and therefore no image will be projected into these areas.

Next, the processor 16 performs patch by patch warping modification of the image to be projected based on the depth to the camera as indicated at block 30. In other words, the computer provides a modification to the local region of the image to be projected based on camera depth. This can be done using a variety of algorithms including a simple linear algorithm that distorts the image based on depth regardless of the curvature, the curvature being accounted for by the array of samples that are taken. In effect then, a complex surface is refined into a series of patches with simpler configurations that are more easily accounted for in the modification algorithm.

Finally the changes provided for each patch are transferred to the image itself, the image to be projected is thereby modified or transformed so that a modified image is provided to the projector for projection onto the display surface as indicated in block 32.

In some embodiments, complexity in terms of sample points may be different for different portions of the image. For example, connected components labeling may be used to identify flat surface areas in the depth camera image. These flat surface areas called labels or blobs may be determined based on the coloring of the depth image wherein objects of the same color are at the same distance from the camera. Then, in areas that are flat, less complexity is inherent and therefore fewer samples may be used. In areas with greater complexity, more or less sample points may be used.

In some embodiments, an irregular array of sample points may be generated that corresponds to each label or blob within the depth image.

In some embodiments, it may be presumed that the user's focus will be at the center of the image and therefore the sample granularity may be greater within a region proximate to the center of the displayed image and less dense at areas around that center region. In some embodiments, the center region may be oval-shaped.

The following clauses and/or examples pertain to further embodiments:

One example embodiment may be a method comprising receiving a depth image of a display surface, determining a number of samples based on the complexity of the display surface, preparing a depth array including depths of said array of samples, and modifying a planar image to be projected for a surface configuration of said display surface using said depth array. The method may include adapting the image to be projected for curvature in said display surface. The method may include modifying an image patch around a sample based on the sample's distances from the display surface. The method may include combining a plurality of patches to modify a planar image to be projected to account for surface contours on said display surface. The method may include determining surface complexity by counting a number of edges in a depth image. The method may include using a unitary depth camera and projector.

Another example embodiment may be one or more non-transitory computer readable media storing instructions to perform a sequence comprising receiving a depth image of a display surface, determining a number of samples based on the complexity of the display surface, preparing a depth array including depths of said array of samples, and modifying a planar image to be projected for a surface configuration of said display surface using said depth array. The media may further store instructions to perform a sequence including adapting the image to be projected for curvature in said display surface. The media may further store instructions to perform a sequence including modifying an image patch around a sample based on the sample's distances from the display surface. The media may further store instructions to perform a sequence including combining a plurality of patches to modify a planar image to be projected to account for surface contours on said display surface. The media may further store instructions to perform a sequence including determining surface complexity by counting a number of edges in a depth image. The media may further store instructions to perform a sequence including using a unitary depth camera and projector.

In another embodiment may be an apparatus comprising a processor to receive a depth image of a display surface, determine a number of samples based on the complexity of the display surface, prepare a depth array including depths of said array of samples, and modify a planar image to be projected for a surface configuration of said display surface using said depth array, and a memory coupled to said processor. The apparatus may include said processor to adapt the image to be projected for curvature in said display surface. The apparatus may include said processor to modify an image patch around a sample based on the sample's distances from the display surface. The apparatus may include said processor to combine a plurality of patches to modify a planar image to be projected to account for surface contours on said display surface. The apparatus may include said processor to determine surface complexity by counting a number of edges in a depth image. The apparatus may include a depth camera and projector.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

1. A method comprising:
receiving a depth image of a display surface;
determining a number of samples based on the complexity of the display surface;
preparing a depth array including depths of said array of samples; and
modifying a planar image to be projected for a surface configuration of said display surface using said depth array.

2. The method of claim 1 including adapting the image to be projected for curvature in said display surface.

3. The method of claim 1 including modifying an image patch around a sample based on the sample's distances from the display surface.

4. The method of claim 3 including combining a plurality of patches to modify a planar image to be projected to account for surface contours on said display surface.

5. The method of claim 1 including determining surface complexity by counting a number of edges in a depth image.

6. The method of claim 1 including using a unitary depth camera and projector.

7. One or more non-transitory computer readable media storing instructions to perform a sequence comprising:
receiving a depth image of a display surface;
determining a number of samples based on the complexity of the display surface;
preparing a depth array including depths of said array of samples; and
modifying a planar image to be projected for a surface configuration of said display surface using said depth array.

8. The media of claim 7, further storing instructions to perform a sequence including adapting the image to be projected for curvature in said display surface.

9. The media of claim 7, further storing instructions to perform a sequence including modifying an image patch around a sample based on the sample's distances from the display surface.

10. The media of claim 9, further storing instructions to perform a sequence including combining a plurality of patches to modify a planar image to be projected to account for surface contours on said display surface.

11. The media of claim 7, further storing instructions to perform a sequence including determining surface complexity by counting a number of edges in a depth image.

12. The media of claim 7, further storing instructions to perform a sequence including using a unitary depth camera and projector.

13. An apparatus comprising:
a processor to receive a depth image of a display surface, determine a number of samples based on the complexity of the display surface, prepare a depth array including depths of said array of samples, and modify a planar image to be projected for a surface configuration of said display surface using said depth array; and
a memory coupled to said processor.

14. The apparatus of claim 13, said processor to adapt the image to be projected for curvature in said display surface.

15. The apparatus of claim 13, said processor to modify an image patch around a sample based on the sample's distances from the display surface.

16. The apparatus of claim 15, said processor to combine a plurality of patches to modify a planar image to be projected to account for surface contours on said display surface.

17. The apparatus of claim 13, said processor to determine surface complexity by counting a number of edges in a depth image.

18. The apparatus of claim 13, including a depth camera and projector.
